(19) United States
(12) Patent Application Publication
(10) Pub. No.: US 2014/0016328 A1
(43) Pub. Date: Jan. 16, 2014

(54) Decorative apparatus for adorning a frustum shaped article

(71) Applicant: J & S DESIGN STUDIO, LLC, Weston, CT (US)

(72) Inventors: Suzanne D. NOVIK, Weston, CT (US); Janice BULLARD, South Salem, NY (US)

(73) Assignee: J & S DESIGN STUDIO, LLC, Weston, CT (US)

(21) Appl. No.: 13/827,844

(22) Filed: Mar. 14, 2013

Related U.S. Application Data
(60) Provisional application No. 61/669,869, filed on Jul. 10, 2012.

(51) Int. Cl. F21V 1/14

(52) U.S. Cl. CPC F21V 1/143
USPC 362/359

(57) ABSTRACT

The present invention relates to a decorative apparatus comprising a first base member having a closed-loop configuration with a perimeter and one or more decorative elements connected to the first base member. The first base member of the decorative apparatus is configured to hold the decorative apparatus to a frustum shaped article by constriction around the article at a position on the article where the perimeter of the decorative apparatus is equal to or less than a perimeter of the article at that position.

### CROSS REFERENCE TO RELATED APPLICATIONS

This application claims priority to U.S. Provisional Application No. 61/669,869 filed on Jul. 10, 2012, which is hereby incorporated by reference in its entirety.

### FIELD OF INVENTION

The present invention relates to an apparatus for adorning a lamp shade or other frustum shaped article and the means for affixing the apparatus to the frustum shaped article.

### BACKGROUND OF INVENTION

It is known in the art that decorative pieces may be affixed to lamp shades and similar items for decorative purposes. However, what is needed is an apparatus that is configured to secure itself to a lamp shade or other frustum shaped article by constriction in order to prevent the article from falling off of the lamp shade and to minimize any unnecessary damage to the lamp shade.

### SUMMARY OF THE INVENTION

The present invention is directed to a decorative apparatus that is configured to hold itself against a frustum shaped article, such as a lamp shade, by means of constriction, in order to provide additional decorative components to the frustum shaped article.

According to a first embodiment, the decorative apparatus according to the present invention comprises a first base member having a closed-loop configuration with a first perimeter, and one or more decorative elements connected to the first base member. The first base member is configured to hold the decorative apparatus to a frustum shaped article by constriction around the article at a position on the article where said first perimeter is substantially equal to a perimeter of said article at said position.

According to the first embodiment of the invention, the frustum shaped article is substantially frustoconical and the first base member is conformable to be substantially circular.

According to the first embodiment of the invention, the one or more decorative elements comprise a plurality of chain-like elements. The plurality of chain like elements may also form the first base member. The decorative apparatus may also comprise a second base member having a closed-loop configuration with a second perimeter greater than said first perimeter.

According to the first embodiment of the invention, the decorative apparatus may further comprise one or more pins configured to affix the decorative apparatus to the article, thereby reducing movement of the decorative apparatus relative to the article. Each of the one or more pins may also comprise a decorative element.

According to a second embodiment of the present invention, there is an arrangement for incorporating decorative elements to a lamp shade comprising: a lamp shade, and a decorative apparatus comprising: a first base member having a closed-loop configuration with a first perimeter, and one or more decorative elements connected to the first base member. The first base member is configured to hold the decorative apparatus to the lamp shade by constriction around the lamp shade at a position on the lamp shade where the first perimeter is substantially equal to a perimeter of the lamp shade at that position.

According to a third embodiment of the present invention, there is an arrangement for incorporating decorative elements to a lamp shade comprising: a lamp shade, and a decorative apparatus comprising: a first base member having a closed-loop configuration with a first perimeter, and one or more decorative elements connected to the first base member. The first base member is configured to hold the decorative apparatus to the lamp shade by constriction around the lamp shade at a position on said lamp shade where the first perimeter is substantially equal to or less than a perimeter of the lamp shade at that position. The arrangement further comprises one or more pins configured to affix the decorative apparatus to the article, thereby reducing movement of the decorative apparatus relative to the article.

### BRIEF DESCRIPTION OF THE DRAWINGS

FIG. 1 is a perspective view of the decorative apparatus according to the first embodiment affixed to a lamp shade.

FIG. 2 is a perspective view of the decorative apparatus according to a second embodiment affixed to a lamp shade.

FIG. 3 is a cross section view of a lamp shade and the decorative apparatus, where the decorative apparatus includes a pin inserted through a portion of the decorative apparatus and lamp shade according to the invention.

FIG. 4 is a cross section view of a lamp shade and the decorative apparatus, where the decorative apparatus includes a pin inserted through a portion of the decorative apparatus and lamp shade according to the invention.

FIG. 5 is a front perspective view of a pin inserted through a portion of the decorative apparatus according to the invention.

FIG. 6 is an exploded perspective view showing the inside of a lamp shade, and a pin inserted through the decorative apparatus and lamp shade according to the invention.

FIG. 7 is a perspective view of a decorative apparatus according to the invention which is further affixed to a lamp shade by a plurality of pins.

FIG. 8 is an interior view of a decorative apparatus according to the invention which is further affixed to a lamp shade by a plurality of pins.

FIG. 9 is a perspective view of a plurality of decorative apparatuses according to an embodiment of the invention affixed to a lampshade.

### DETAILED DESCRIPTION OF THE DRAWINGS

The decorative apparatus according to the present invention can be used in conjunction with a separate, common article such as a lamp shade, in order to provide additional decorative components to the article, while also being easy for an individual to add to or remove the decorative apparatus from the article.

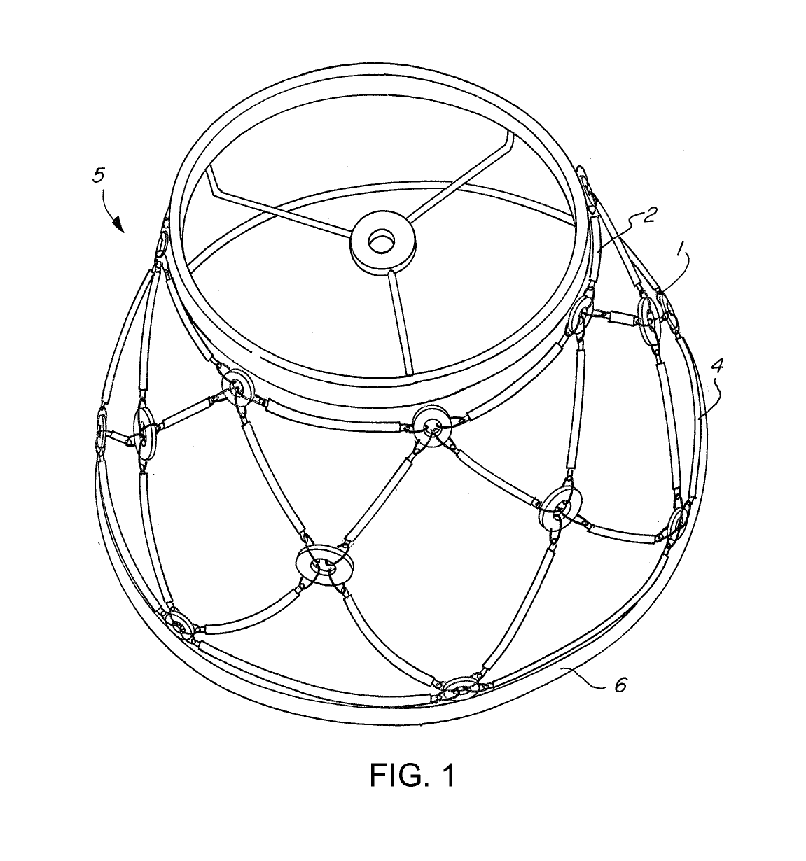

As seen in FIG. 1, the decorative apparatus 1 comprises a first base 2 that consists of a closed loop configuration. The first base 2 may either be a rigidly set into a pre-defined shape, such as a circle, square or rectangle for example, or it may be conformable to one or more different closed loop shapes.

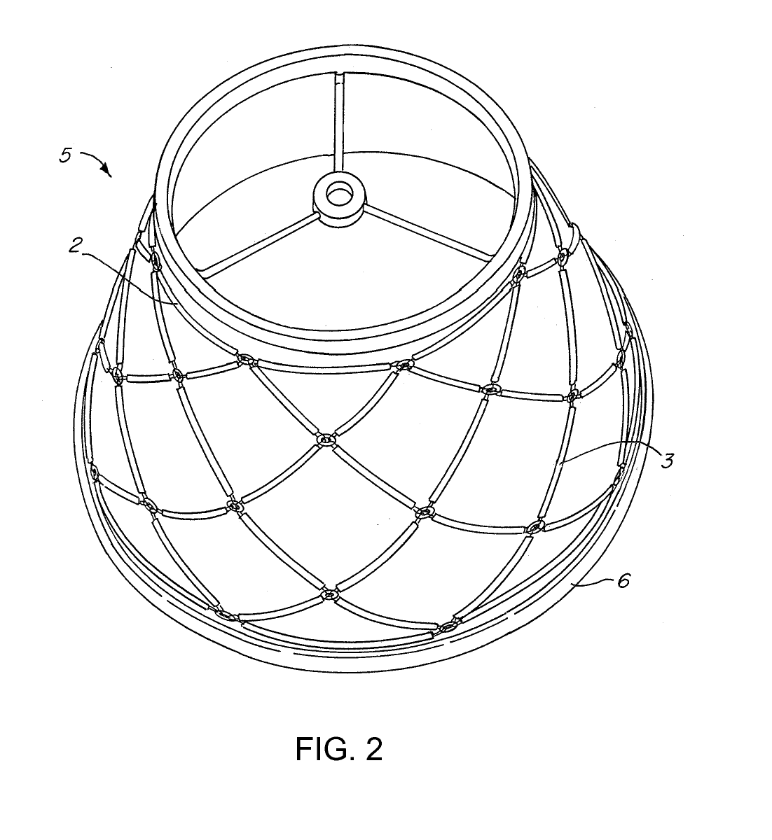

The decorative apparatus 1 may also comprise one or more decorative elements 3 that are connected to the first base 2. The one or more decorative elements 3 can take the form of one of many forms, such as those typically associated with jewelry items. For example, in the decorative apparatus 1 shown in FIG. 1, the decorative elements 3 comprise a series of chains. In the decorative apparatus 1 as shown in FIG. 2, the decorative elements 3 are in the form of a series of interlocking pieces. The first base 2 may also comprise the same elements that are used as the one or more decorative elements 3, such that the entire decorative apparatus 1 comprises the same items. For example, this can be seen in the decorative apparatuses 1 shown in the Figures.

The decorative apparatus 1 may also comprise a second base 4 that is connected to the first base 2 by means of the one or more decorative elements 3. The second base 4 also is in the form of a closed loop similar to the first loop. However, the perimeter of the second base 4 is greater than or equal to the perimeter of the first base 2. The second base 4 may also comprise same elements that comprise the one or more decorative elements 3 and/or the first base 2.

The decorative apparatus 1 can be used as part of an arrangement 5 with a frustum shaped article 6 in order to add decorative components to the article 6. In the examples shown in FIGS. 1-2, the frustum shaped article 6 is a substantially frustoconical lamp shade 6. However, the article 6 may take other shapes or forms.

To apply the decorative apparatus 1 to the article 6, the decorative apparatus 1 is placed over the top of the frustum shaped article 6. The decorative apparatus 1 is slid down the article 6 until the first base 2 reaches a position on the article 6 where the perimeter of the first base 2 is substantially equal to the perimeter of the article 6 at that position. At this position, the first base 2 constricts against the article 6 and prevents the first base 2 from sliding further down the article 6. From this position, the one or more decorative elements 3, and if present the second base 4, may fall downward from the first base 2 by gravity, and adorn the portion of the article 6 below the position of the first base 2.

The invention may also comprise one or more headpins or pin-like elements 7 to further secure the decorative apparatus 1 to the lamp shade 6 or other article. These pins 7 can be inserted through a part of the decorative apparatus 1, such as a decorative element 3, and through the lamp shade 6, and secured in position from inside the lamp shade 6. For example, if the decorative apparatus 1 includes a chain or chains as the one or more decorative elements 3, one or more pins 7 can be inserted through links in the chain. By using pins, the decorative apparatus 1 is secured to the lamp shade 6 such that movement of the decorative apparatus 1 relative to the article is restricted. Thus, if the lamp shade 6 is inadvertently bumped, for example, the decorative apparatus 1 remains substantially in place.

The inclusion and use of one or more pins 7 may also provide further decorative components to the arrangement 5 of the decorative apparatus 1 and lamp shade 6. The one or more pins 7 may comprise decorative components on the head 9 of the pin 7, which when used in conjunction with the decorative apparatus 1 and the decorative elements contained therein, adds further decorative components to the arrangement 5. Alternatively, a pin 7 may be used to affix an additional decorative element 10 to the arrangement by placing the additional decorative element 10 on the decorative apparatus 1 and securing the pin 7 through the additional decorative element 10, the decorative apparatus 1 and the lamp shade 6 or other article.

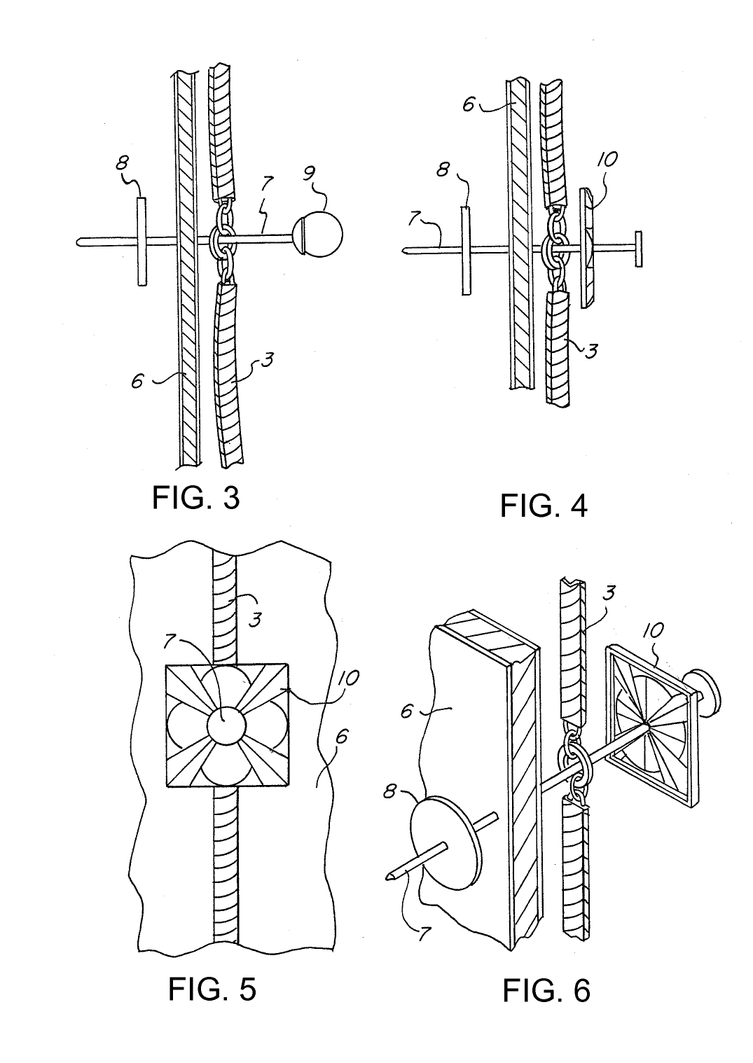

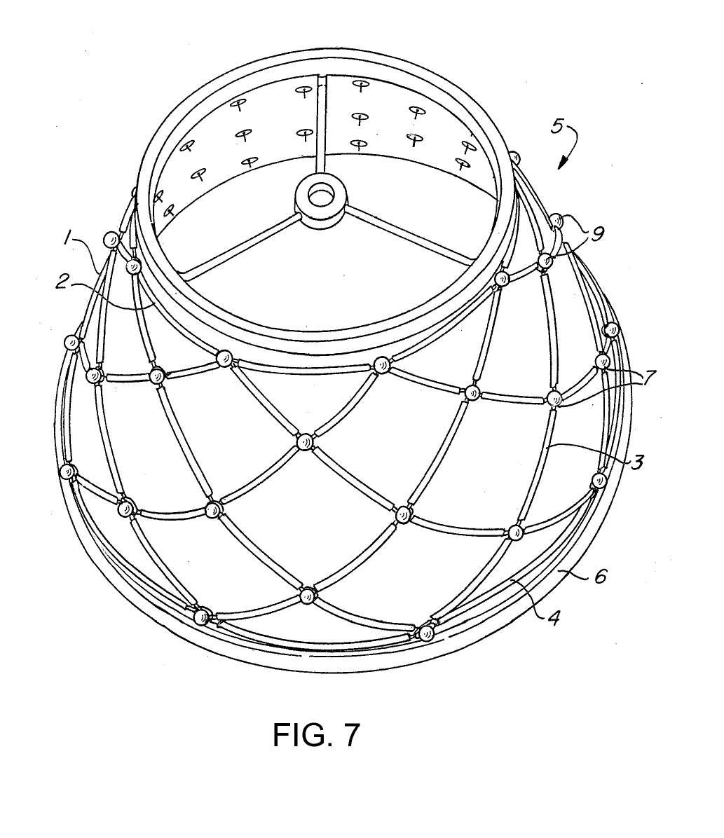

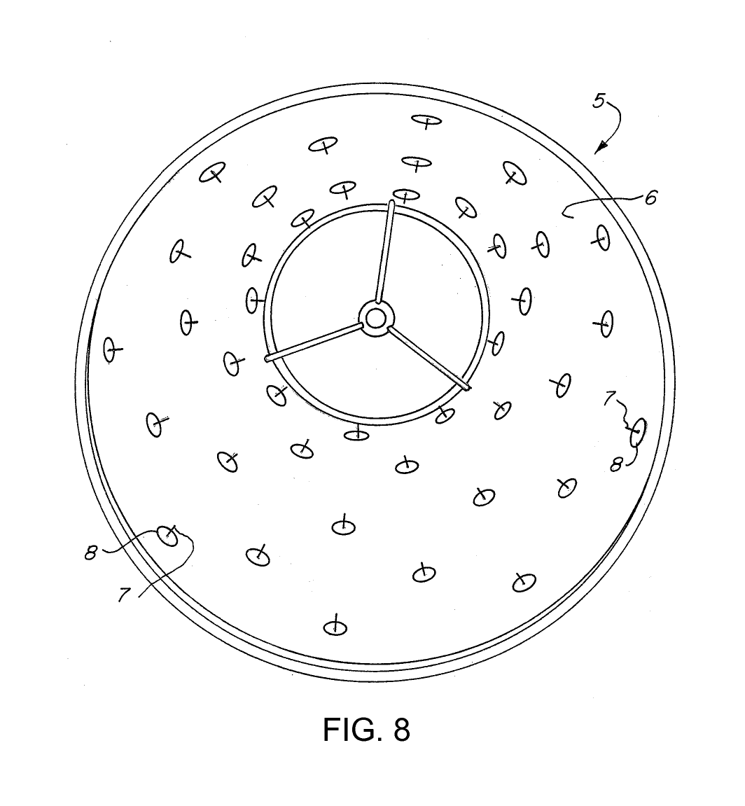

Different aspects of the use of one or more headpins 7 in conjunction with the invention are depicted in FIGS. 3-8. FIG. 3 shows a cross-sectional view of a pearl headpin 7, threading through a chain 3 in the decorative apparatus 1 and piercing the shade 6 with a clear plastic disk 8 used on the inside of the lamp shade 6 as a reinforcement mechanism. “In an alternative embodiment, a metal bead (not shown) may be used as a reinforcement mechanism in place of the clear plastic disk 8.” FIG. 4 shows a cross-sectional view of a flat headpin 7, threading through an additional decorative element 10, then through a chain 3 in the decorative apparatus 1 and piercing the shade 6 with a clear plastic disk 8 used on the inside of the shade 6 as a reinforcement mechanism. FIG. 5 shows a front view of a crystal headpin 7, threading through an additional decorative element 10 and a decorative component 3. FIG. 6 shows the clear plastic disk 8 and the pin 7 from the perspective of the inside of the shade 6 with the end of the headpin 7 curled tightly to secure all components of the arrangement in place. FIG. 7 shows an example of the arrangement 5, wherein the decorative apparatus 1 is further affixed to the shade 6 by means of a plurality of pearl headpins 7 to display the plurality of pearls 9. FIG. 8 depicts the arrangement 5 of FIG. 7 from inside the lamp shade 6, where the plurality of pins 7 are affixed to the lamp shade 6 by a plurality of clear plastic disks 8.

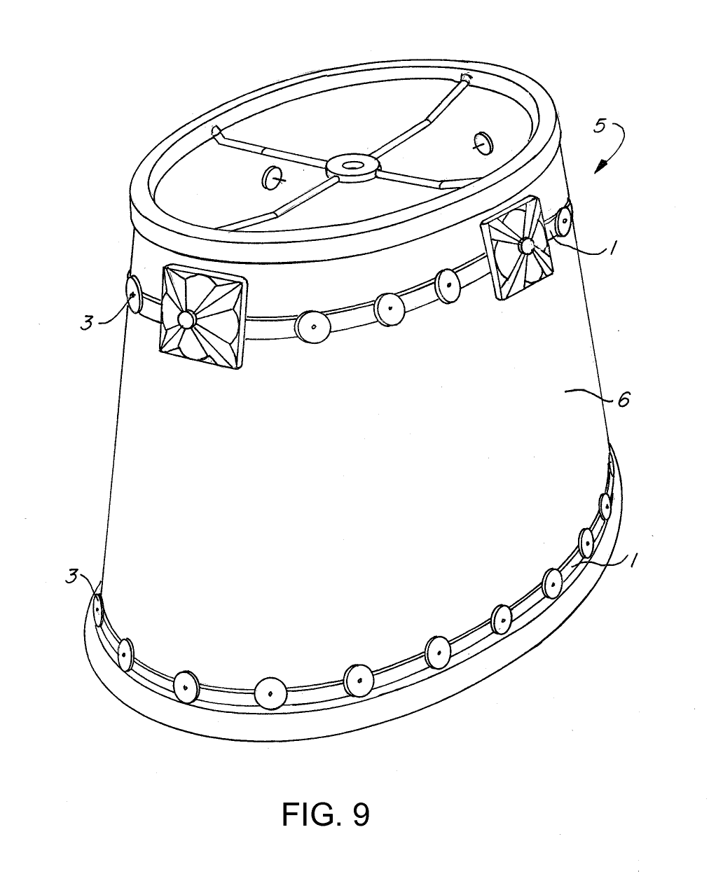

In an alternative embodiment, the decorative apparatus 1 of the present invention may also be configured such that more than one apparatus can be affixed to the same frustum shaped article 6. An example of this embodiment of the invention is depicted in FIG. 9. A plurality of decorative apparatuses 1 are affixed to a lampshade 6. Although FIG. 9 depicts each apparatus 1 positioned at the top and bottom of the lampshade, the invention is not limited to such an arrangement.

What is claimed is:

1. A decorative apparatus comprising:
a first base member having a closed-loop configuration with a first perimeter, and
one or more decorative elements connected to said first base member,
wherein said first base member is configured to hold said decorative apparatus to a frustum shaped article by constriction around said article at a position on said article where said first perimeter is equal to or less than a perimeter of said article at said position.

2. The decorative apparatus of claim 1, wherein said article is substantially frustoconical.

3. The decorative apparatus of claim 2, wherein said first base member is conformable to be substantially circular.

4. The decorative apparatus of claim 1, wherein said article is a lamp shade.

5. The decorative apparatus of claim 1, wherein said one or more decorative elements comprise a plurality of chain-like elements.

6. The decorative apparatus of claim 1, further comprising a second base member having a closed-loop configuration with a second perimeter greater than said first perimeter.

7. The decorative apparatus of claim 5, wherein said plurality of chain like elements further form said first base member.

8. The decorative apparatus of claim 1, wherein said decorative apparatus further comprises one or more pins configured to affix the decorative apparatus to said article, thereby reducing movement of said decorative apparatus relative to said article.

9. The decorative apparatus of claim 8, wherein each of said one or more pins comprises a decorative element.

10. An arrangement for incorporating decorative elements to a lamp comprising:
a lamp shade, and
a decorative apparatus comprising:
a first base member having a closed-loop configuration with a first perimeter, and
one or more decorative elements connected to said first base member,
wherein said first base member is configured to hold said decorative apparatus to the lamp shade by constriction around said lamp shade at a position on said lamp shade where said first perimeter is equal to or less than a perimeter of said lamp shade at said position.

11. The arrangement of claim 10, wherein the lamp shade is substantially frustoconical.

12. The arrangement of claim 11, further comprising a second base member having a closed-loop configuration with a second perimeter greater than said first perimeter.

13. An arrangement for incorporating decorative elements to a lamp shade comprising:
a lamp shade, and
a decorative apparatus comprising:
a first base member having a closed-loop configuration with a first perimeter, and
one or more decorative elements connected to said first base member,
wherein said first base member is configured to hold said decorative apparatus to a lampshade by constriction around said lamp shade at a position
on said lamp shade where said first perimeter is equal to or less than a perimeter
of said lamp shade at said position, and
wherein said arrangement further comprises one or more pins configured to affix the decorative apparatus to said article, thereby reducing movement of said decorative apparatus relative to said article.

14. The arrangement of claim 10, wherein the lamp shade is substantially frustoconical.

15. The arrangement of claim 11, further comprising a second base member having a closed-loop configuration with a second perimeter greater than said first perimeter.
